(19) United States
(12) Patent Application Publication
(10) Pub. No.: US 2021/0113316 A1
(43) Pub. Date: Apr. 22, 2021

(54) A DENTAL LIGHT POLYMERIZATION DEVICE

(71) Applicant: 3M INNOVATIVE PROPERTIES COMPANY, St. Paul, MN (US)

(72) Inventors: Heiko Duwensee, Landsberg (DE); Stefan K. Welker, Geltendorf (DE); Rudolf Schmid, Eichenau (DE); Kathleen M. Stenersen, St. Paul, MN (US)

(21) Appl. No.: 16/493,880

(22) PCT Filed: Mar. 14, 2018
(86) PCT No.: PCT/US2018/022306

§ 371 Date: Sep. 13, 2019

(30) Foreign Application Priority Data
Mar. 17, 2017 (EP) 17161489.4

(51) Int. Cl. A61C 13/15; A61C 7/14

(52) U.S. Cl. CPC A61C 19/004; A61C 7/146

(57) ABSTRACT

A dental light polymerization device (1) that has an intra-oral tip portion (5) forming a polymerization light output (4) and an image input (2). The dental light polymerization device has a polymerization light source (3) for emitting polymerization light toward the polymerization light output and a camera for receiving images from the image input. The tip portion has a circumferential rim that forms a circumferential inner side face or a pair of projections that form opposite inner side faces. The polymerization light output is at least partially formed by the inner side face(s).

### FIELD OF THE INVENTION

The invention relates to a dental light polymerization device which has a polymerization light source and a camera. In more particular the invention relates to a dental light polymerization device which has a light deflection member for deflecting light underneath an orthodontic bracket.

### BACKGROUND ART

Light hardenable or light curable materials are widely used in dentistry for the restoration of teeth. Further, light hardenable materials, in particular light hardenable adhesives, are used in orthodontics to bond orthodontic brackets to a patient's teeth.

Light hardenable materials typically include a polymerizable matrix material and may initially be generally soft or flowable so that they can be applied in a desired location and shape. For example, for bonding a bracket to a patient's tooth the dental material may be provided between the bracket and the tooth. Once the bracket is positioned to the desired location, the material is hardened by exposing it to light of a desired wavelength. The light typically activates photoinitiators in the dental material that cause the matrix material to polymerize.

In dentistry and orthodontics light hardenable materials are used that can be hardened by blue light of a wavelength of between about 450 and 500 nm (nanometers). Accordingly, light-emitting devices used for hardening such light hardenable materials typically emit light at such wavelengths. Such a light-emitting device is for example available from 3M Deutschland GmbH, Germany, under the trade designation Elipar™ S10.

The hardening of light hardenable materials in orthodontics is often somewhat challenging, because the bracket typically shields major portions of the light hardenable material from light that directed toward the tooth to which the bracket is intended to be bonded. Because orthodontic brackets are typically made of opaque materials, for example metal, the light hardenable material sandwiched between the bracket and the tooth is typically exposed to only a minor portion of the light directed to the tooth that carries the bracket. This can lead to enhanced curing times with respect to a curing time of the same light hardenable material when directly exposed to the light. To address this challenge it has been proposed to direct light directly between the bracket and the tooth.

For example US 2008/0166677 discloses a light directing and amplifying device for attachment to a dental curing device used in light cure bonding orthodontic brackets to teeth. An internal mirror directs the light 90 degrees from the light source, directly under the back side of the bracket, thus directly curing the light cure adhesive enhancing the cure and rate of cure.

Although there are existing approaches for hardening light hardenable materials in orthodontics there is still a desire for a dental light polymerization device that facilitates the bonding of brackets to a patient's teeth.

### SUMMARY OF THE INVENTION

The invention relates to a dental light polymerization device that comprises an intra-oral tip portion (further referred to as “tip portion” herein). The tip portion that forms a polymerization light output and an image input. The dental light polymerization device further comprises a polymerization light source for emitting polymerization light toward the polymerization light output and a camera for receiving images from the image input. The tip portion comprises circumferential rim that forms a circumferential inner side face. Alternatively the tip portion comprises a pair of projections that form opposite inner side faces. The polymerization light output is at least partially formed by the inner side face or inner side faces.

The invention is advantageous in that it allows the light hardening of a light hardenable material sandwiched between an opaque bracket and a natural tooth. The invention is further advantageous in that it facilitates the positioning of the dental light polymerization device relative to the bracket. Further, the invention allows the positioning of the dental light polymerization device to be controlled and the position of the bracket relative to the tooth to be checked.

Also disclosed herein, but presently not claimed, is a dental light polymerization device according to the invention in which the image input and the camera are optional. Such device is further referred to as “non-camera device”. The following embodiments belong to the dental light polymerization device of the invention as well as to the non-camera device.

In a preferred embodiment the polymerization light is blue light. For the purpose of the present specification the term “blue light” refers to light having a wavelength within the range of about 430 nm to 500 nm, preferably within a range of about 430 nm to 480 nm. Blue light preferably predominantly consists of light within a range of about 430 nm to 480 nm. The blue light may particularly not comprise light having a wavelength outside the range of about 430 nm to 480 nm at a substantial intensity or at all. In particular, blue light may have a first portion of light within a range of about 430 nm to 480 nm and preferably does not have a significant second light portion within a range of 570 nm and 590 nm, wherein the maximum intensity of the second portion of light is preferably less than 10% and more preferably less than 1% of the maximum intensity of the first portion of light. Further blue light may not have a significant third light portion within the spectrum of visible light outside the range of 430 nm and 480 nm and outside the range of 570 nm to 590 nm, wherein the maximum intensity of any third portion of light is preferably less than 25% and more preferably less than 20% of the maximum intensity of the first portion of light.

In one embodiment a recess is formed by the circumferential inner side face or between the inner side faces. The recess is preferably dimensioned to accommodate an orthodontic bracket therein. For example, the recess may have a diameter or width of between about 8 mm and 12 mm, preferably about 10 mm. The image input is preferably arranged inside the recess.

In one embodiment the rim or the projections are formed by a light deflection member. The light deflection member may be a fixed component of the dental light polymerization device. Alternatively, the light deflection member may be removably attachable to the dental light polymerization device. The light deflection member may be made of a transparent plastic material or glass, for example.

In one embodiment the dental light polymerization device comprises a reflector for deflecting light emitted from the polymerization light source toward the inner side face(s). In particular, the reflector is preferably arranged on the light deflection member. The polymerization light source preferably emits light along a common optical axis which for the purpose of the present specification corresponds to the axis of symmetry of a light beam emitted from the polymerization light source. The reflector is preferably inclined relative to the optical axis by an angle α that is smaller than 45 degrees and greater than 0 degrees, in particular greater than 30 degrees. Thus, a portion of the polymerization light is deflected laterally by the deflector. In other words the reflector is configured for deflecting a portion of the polymerization light in a flat cone or a flat V-shaped ribbon. The cone angle (which is the included angle measured between opposites sides of the cone) is preferably less than 180 degrees and greater than 90 degrees, more preferably greater than 140 degrees, most preferably greater than or equal to 160 degrees. It has been found that thus light emitted toward a light hardenable material arranged between the bracket and a tooth not only directly impinges on the light hardenable material. Rather, a portion of the light impinges on a tooth area around the bracket and is guided within the tooth toward a tooth facing bonding surface of the light hardenable material. Therefore, the reliability of hardening the light hardenable material can be maximized. Further, the time for hardening the light hardenable material can be minimized.

In a further embodiment the reflector is formed by a metal layer. The metal layer may be an aluminum coating, for example, or any other light reflecting layer.

In an embodiment the metal layer is provided on an outer surface of the rim. The outer surface of the rim is preferably conical, in particular frustroconical. Accordingly, the metal layer and thus the reflector is conical, in particular frustroconical. The metal layer may further be provided on outer surfaces of the projections. The outer surfaces of the projections are preferably inclined relative to each other, in particular at a V-shape. In a further embodiment the dental light polymerization device comprises a cover that is provided in or on the tip portion. For example the cover may close an opening in the tip portion, for example hermetically seal the opening in the tip portion. The cover is preferably transparent. The light deflection member may be arranged on the cover. Alternatively the light deflection member may be formed by the cover, for example may be monolithically formed by the cover.

In an embodiment the dental light polymerization device further comprises a plurality of polymerization light emitters forming the polymerization light source. Preferably, each of the polymerization light emitters are formed by a blue LED (Light Emitting Diode). A blue LED as referred to herein emits blue light as specified herein. In a further embodiment the plurality of polymerization light emitters are circumferentially arranged in a circle. The image input is preferably arranged at the center of the circle or axially spaced from the center of the circle. In the non-camera device the image input is optional, however, the plurality of light emitters are preferably circumferentially arranged in a circle. Thus, the light emitters are arranged for emitting, in combination, light in a ring-shaped fashion. Therefore in a process of bonding brackets to a patient's tooth, the shape of the light emitted from the device provides for radiation of the relevant areas. This is because for hardening of a light hardenable material or adhesive between a tooth and a bracket the light is preferably directed toward the margin of a bracket base (which is typically the portion of the bracket bonded to a tooth).

In one embodiment the dental light polymerization device further comprises an illumination light source. The illumination light source is preferably configured for emitting illumination light toward an illumination light output. Preferably the illumination light is white light.

For the purpose of the present specification the term “white light” refers to light having a wavelength within a range of about 380 nm to 780 nm. Although white light may also comprise light at wavelengths overlapping with the range of wavelengths of blue light, the white light preferably does not predominantly consist of light within that range but has significant portions of visible light at wavelengths outside that range.

The illumination light source is preferably formed by a plurality of illumination light emitters. Each of the illumination light emitters are formed by a white LED (Light Emitting Diode). A white LED as referred to herein emits white light as specified herein.

In one embodiment the dental light polymerization device comprises a light refraction panel in which a plurality of lenses are interspersed. The light refraction panel is preferably arranged with the lenses being each positioned in front of a corresponding polymerization light emitter of the polymerization light source. For example, the dental light polymerization device may have four polymerization light emitters (for example blue LEDs) that are circularly arranged at 0 degrees, 90 degrees, 180 degrees and 270 degrees around the image input. The diameter of the circle of the circular arrangement is preferably about 10 mm. Further, the image input is preferably arranged in the middle of the circle of the circular arrangement. The light refraction panel may be spaced from the polymerization light emitters by a distance of between 1 mm and 4 mm, preferably 2 mm.

The lenses are preferably freeform lenses. The freeform lenses are preferably configured such that the light emitted from the polymerization light source, in particular from the polymerization light emitters (or LEDs), is refracted toward a parallel light beam having a uniform light distribution. The freeform lenses are preferably customized with respect to both, the optical characteristics of the polymerization light source and the desired optical characteristics of the polymerization light beam emitted from the light refraction panel.

According to the present invention the polymerization light that is emitted from the dental light polymerization device is preferably parallel and uniformly distributed. Based on the desired parallel and uniform characteristic the lenses are preferably designed for, in combination, compensating any non-parallel and non-uniform light emitted from the polymerization light source. The lenses preferably have a lens surface topography that is customized with respect to the characteristics of the polymerization light source and accounting for intended characteristics of the polymerization light emitted from the dental light polymerization device. In particular the surfaces of the lenses preferably do not have one common axis of rotation. In other words the freeform lenses are typically not rotation-symmetric.

In one embodiment the camera and the polymerization light source are arranged within the tip portion. In particular, the camera, the polymerization light source and the illumination light source are preferably arranged within the tip portion. For example, the camera, the polymerization light source and the illumination light source may be arranged on a common first printed circuit that is accommodated with the tip portion.

In a further embodiment the dental light polymerization device comprises at least a second printed circuit board that is arranged within a handle portion of the dental light polymerization device. The second printed circuit board preferably carries electronic circuitry for electrically operating the LEDs and/or the camera. The first and second printed circuit board are preferably electrically connected via a flexible printed circuit board, but may also be connected by electric wires.

In another embodiment the polymerization light source is arranged within a handle portion of the dental light polymerization device. Such a device preferably has a light guide extending from the handle portion. A free end of the light guide may form the tip portion (including the light deflection member). Alternatively, the light guide may have a free end onto which the light deflection member (that forms the tip portion) can be placed, in particular removably attached.

A light guide as referred to herein preferably comprises a plurality of glass fibers which extend in parallel along a straight and/or curved axis. The light guide is thus configured to guide light along the axis of the light guide.

In a further embodiment the dental light polymerization device comprises a wireless communication unit. The wireless communication unit is preferably configured for wirelessly transmitting images captured by the camera to an image display.

In a preferred embodiment the dental light polymerization device comprises a, preferably rechargeable, battery for powering the dental light polymerization device. Thus, the dental light polymerization device can be operated wireless, in particular without a power and/or any data wire.

### BRIEF DESCRIPTION OF THE FIGURES

FIG. 1 is a perspective view of a dental light polymerization device according to an embodiment of the invention;

FIG. 2 is a partial perspective cross-sectional view of a dental light polymerization device according to an embodiment of the invention;

FIG. 3 is a partial perspective cross-sectional view of a further dental light polymerization device according to an embodiment of the invention; and

FIG. 4 illustrates the measuring of an angle with respect to an embodiment of the invention.

### DETAILED DESCRIPTION OF THE INVENTION

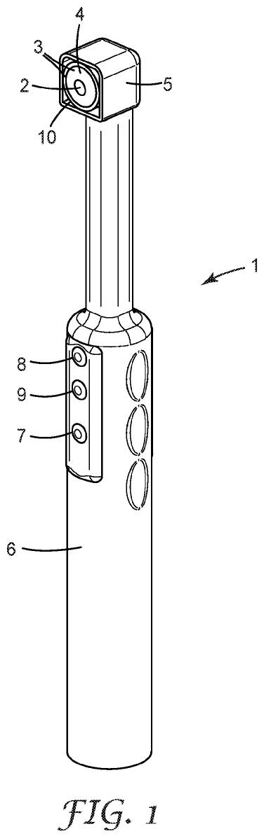

FIG. 1 shows a dental light polymerization device 1. The dental light polymerization device 1 has a tip portion 5 and a handle portion 6. Further, the dental light polymerization device 1 has an image input 2 that comprises a camera (not visible in this view), a polymerization light output 3 for emitting blue light and an illumination light output 4 for emitting white light.

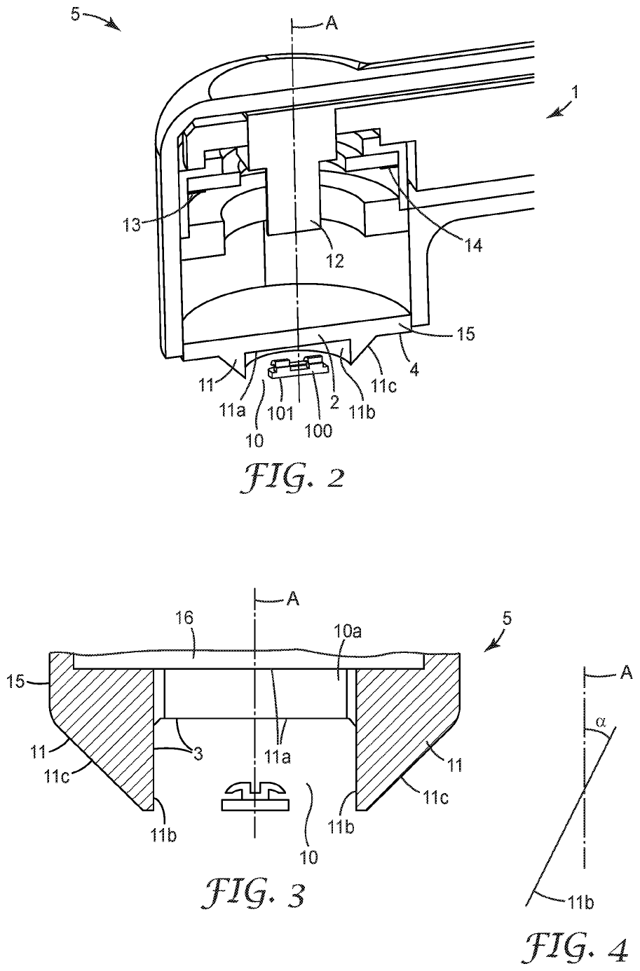

The tip portion 5 (further shown in detail in FIG. 2) comprises or forms a recess 10 that has a bottom face 11a from which a surrounding circumferential inner side face 11b extends. The inner side face 11b is formed by a rim 11 that projects relative to and away from the bottom face 11a. The image input 2 is formed by the bottom face 11a and the polymerization light output 3 is formed by the bottom face 11a and inner side face 11b.

The recess is sized to accommodate an orthodontic bracket therein. For example the diameter of the recess 10 may be between about 8 mm and about 12 mm, for example about 10 mm. Further, although in the example the recess 10 is circular, in another example the recess may be square-shaped or rectangular. Thus, the recess may essentially correspond in shape with a footprint of a square-shaped or rectangular bracket. It is however noted that the dimension of the recess is preferably greater than the footprint of the bracket. Thereby the dental light polymerization device provides for radiating an area around the bracket by blue light. This helps maximizing the amount of light reaching any light hardenable adhesive between the bracket and the tooth. Due to the recess 10 the polymerization light output 3 is shaped to radiate blue light circumferentially underneath the bracket as further described in detail below.

The light polymerization device 1 in the example has further a polymerization light button 8, a timer setting button 7 and a camera button 9. The polymerization light button 8 enables a user to activate the dental polymerization light device 1 for emitting blue light or deactivate the dental polymerization light device 1. Further, the camera button 9 enables a user to activate or deactivate the camera.

The dental light polymerization device 1 in the example is an overall wireless device, but may in another example be wired. In the example the light polymerization device 1 has a rechargeable battery (not visible in this view). For charging the battery a charging device may be provided (not shown) by which the battery can be charged. For charging the battery the light polymerization device 1 may be connected to the charging device in a contactless manner or by electrical contact-based connection.

FIG. 2 shows the tip portion 5 of the dental polymerization light device 1 in more detail. The polymerization light output 3 comprises a plurality of polymerization light emitters 13, in the example a plurality of blue LEDs. The plurality of polymerization light emitters, in combination, form a polymerization light source of the dental polymerization light device 1. Further, the illumination light output 4 comprises a plurality of illumination light emitters 14, in the example a plurality of white LEDs. Other light emitters than LEDs may be used as appropriate, for example halogen lamps or laser diodes. The plurality of illumination light emitters 14 in combination form an illumination light source of the dental polymerization light device 1. The image input 2 comprises a camera 12. The camera 12 may be a CCD or CMOS based camera, or may be based on any other appropriate technology.

In the example, the camera 12 and the polymerization and the illumination light source 3, 4 (in particular the polymerization and illumination emitters 13, 14) are accommodated within the tip portion 5. Other configurations are possible. For example, the camera, the polymerization and/or the illumination light source may be accommodated in the handle portion of the dental light polymerization device 1. In this case one or more light guide(s) may extend between the camera and the image input and/or between the polymerization/illumination light sources and the polymerization/illumination light outputs. In the example the rim 11 is provided by a transparent light deflection member 15 which forms a closure that closes an opening in the tip portion 5. In another example the light deflection member may be attached to an existing cover or to a light guide of the dental light polymerization device 1. The rim 11 forms the inner side face 11b and an outer side face 11c. The outer side face 11c has a frustroconical shape and is preferably mirrored, for example by a metal coating. Thus, the outer side face 11c forms a reflector which deflects polymerization light emitted from the polymerization light emitters 13 toward the inner side face 11b. The rim 11 further forms a recess 10. Accordingly, a portion of the polymerization light emitted from the polymerization light emitters 13 along an optical axis A is deflected laterally relative to the optical axis A and toward the inside of the recess 10.

Therefore an orthodontic bracket 100 accommodated within the recess 10 can be irradiated by polymerization light from all sides including from lateral sides. Therefore a light hardenable material or adhesive disposed on the tooth facing side 101 of a bracket base of the bracket 100 can be exposed to polymerization light. Accordingly, the light hardenable adhesive can be reliably hardened although being covered by the (typically non-transparent) base of the bracket.

FIG. 3 shows a portion of the tip portion 5 of a further embodiment. The polymerization light output 3 in this example is provided by a bottom face 11a and two opposing inner side faces 11b. The two inner side faces 11b are formed by a groove-shaped recess 10. The recess 10 is provided by a transparent light deflection member 15 which is configured for being attached to an additional cover 16 of the tip portion 5 or which may be attached to a light guide (not shown). In the example the recess 10 comprises a through-hole 10a so that a surface of the cover 16 of the tip portion 5 forms at least part of the bottom face 11a. In another example the through-hole is however optional. Therefore, the bottom face may optionally be provided by the cover 15.

The light deflection member 15 has a pair of opposing projections 11 which each form one of the inner side faces 11b and which each form an outer side face 11c. The outer side faces 11c are planar and inclined relative to an optical axis A. Further, the outer side faces 11c are preferably mirrored, for example by a metal coating. Thus, the outer side faces 11c each form a reflector that deflect polymerization light toward the inner side faces 11b. Accordingly, a portion of the polymerization light emitted along the optical axis A is deflected laterally relative to the optical axis A and toward the inside of the recess 10.

FIG. 4 illustrates the measurement of an angle between the optical axis A of the polymerization light and the reflector at the outer side face 11b for either embodiment (the rim or the ridges).

It has been found that the reflector is preferably inclined to the optical axis at an angle α that is smaller than 45 degrees. Thereby the angle α corresponds to the smallest angle between the optical axis and the reflector so that the corresponding other angle is greater than 135 degrees. Accordingly, in use of the dental light polymerization device for hardening a light hardenable adhesive between a patient's tooth and a bracket, the polymerization light impinges on the tooth surface at a flat angel, thus partly directly reaching the light hardenable adhesive and further partly being guided underneath the bracket through the enamel of tooth. In this regard it has been found that due to the relative transparency of the outermost layers of a natural tooth the enamel acts as a light guide.

1. A dental light polymerization device comprising:
an intra-oral tip portion that forms a polymerization light output and an image input;
a polymerization light source for emitting polymerization light toward the polymerization light output; and
a camera for receiving images from the image input,
wherein the tip portion comprises a circumferential rim that forms a circumferential inner side face, or a pair of projections that form opposite inner side faces, and wherein the polymerization light output is at least partially formed by the inner side face or inner side faces.

2. The dental light polymerization device of claim 1, wherein a recess is formed by the circumferential inner side face or between the inner side faces, and wherein the recess is dimensioned to accommodate an orthodontic bracket therein.

3. The dental light polymerization device of claim 1, comprising a reflector for deflecting light emitted from the polymerization light source toward the inner side face(s).

4. The dental light polymerization device of claim 1, wherein the reflector is formed by a metal layer.

5. The dental light polymerization device of claim 1, wherein the metal layer is provided on an outer surface of the rim or outer surfaces of the projections.

6. The dental light polymerization device of claim 1, further comprising a plurality of polymerization light emitters forming the polymerization light source.

7. The dental light polymerization device of claim 6, wherein each of the polymerization light emitters are formed by a blue LED (Light Emitting Diode).

8. The dental light polymerization device of claim 6, wherein the plurality of polymerization light emitters are circumferentially arranged in a circle and wherein the image input is arranged at the center of the circle or axially spaced from the center of the circle.

9. The dental light polymerization device of claim 6, further comprising a light refraction panel in which a plurality of lenses are interspersed, wherein the light refraction panel is arranged with the lenses being each positioned in front of a corresponding polymerization light emitter of the polymerization light source.

10. The dental light polymerization device of claim 1, further comprising an illumination light source, the illumination light source being formed by a plurality of illumination light emitters.

11. The dental light polymerization device of claim 1, wherein each of the illumination light emitters are formed by a white LED (Light Emitting Diode).

12. The dental light polymerization device of claim 1, wherein the camera and the polymerization light source are arranged within the tip portion.

13. The dental light polymerization device of claim 1, further comprising a wireless communication unit for wirelessly transmitting images captured by the camera to an image display.
